(19) United States
(12) Patent Application Publication
(10) Pub. No.: US 2022/0142159 A1
(43) Pub. Date: May 12, 2022

(54) A METHOD AND COMPOSITION FOR INSECT REPELLENCY USING AVERSIVE AGENT

(71) Applicant: UPL LTD, Haldia (IN)

(72) Inventors: Veera Parasu Uppara, Mumbai (IN); Sanjay Pradnya Lokhande, Mumbai (IN); Ramprakash Krishna Srivastava, Mumbai (IN)

(21) Appl. No.: 17/431,740

(22) PCT Filed: Feb. 20, 2020
(86) PCT No.: PCT/IB2020/051421

§ 371 Date: Aug. 18, 2021

(30) Foreign Application Priority Data
Feb. 20, 2019 (IN) 201931006761

(51) Int. Cl. A01N 37/22; A01N 25/02; A01P 17/00; A01N 25/08

(52) U.S. Cl. CPC A01N 37/22; A01N 25/08; A01P 17/00; A01N 25/02

(57) ABSTRACT

The present invention relates to a composition comprising aversive agent as insect repellant in agriculture and horticulture. The present invention more particularly relates to Denatonium compound which acts as repellant without harming the life of environmentally useful insects such as honey bees, in addition to reptiles such as lizards, also the mammals such as deer, rodents, nilgai.

### FIELD OF INVENTION

The present invention relates to a composition comprising aversive agent (bittering agent) as insect repellant in agriculture and horticulture. The present invention more particularly relates to denatonium compound which acts as repellant without harming the life of environmentally useful insects such as honey bees, in addition to reptiles such as lizards, also the mammals such as deer, rodents, nilgai.

### BACKGROUND OF THE INVENTION

Denatonium benzoate, also known as phenylmethyl-[2-[(2,6-dimethylphenyl)amino]-2-oxoethyl]-diethylammonium benzoate, CAS no. 3734-33-6. Formula: C28H34N2O3 MOLECULAR WEIGHT: 446.58 g/mol

Denatonium benzoate is a quaternary ammonium salt formed by the combination of a cationic quaternary ammonium salt with an inert anion such as benzoate ion or saccharin anion. Having the following structure:

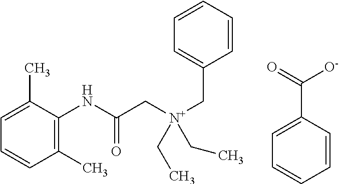 [SMILES: CC[N+](CC)(CC(=O)Nc1c(C)cccc1C)Cc1ccccc1 ; O=C([O-])c1ccccc1]

Denatonium benzoate is listed in the Guiness Book of Records and the Merck Index as “the bitterest substance known to man”. Denatonium benzoate can be detected by the average person at 10 parts per billion (ppb), and has a generally recognized bitter taste at 50 ppb. The normal application range is 6-50 ppm, depending on the nature of the product to which it is added. Bitrex chemically resembles natural bitter substances such as quinine in having a molecular structure with separately charged elements that act on taste receptors. However, clinical trials have proven that its extremely human safe drug.

Denatonium benzoate is generally used as a bittering agent (or aversive agent) to prevent eating of toxic substances. For example, added to industrial alcohol, paint, toilet cleaners, liquid soaps and shampoos in order to prevent poisoning in people, animals. Also, for example, it can be used in a dilute solution to brush on the fingernails of people who are compulsive fingernail-biters or on the thumbs of children who suck their thumbs more than they should. Denatonium benzoate is also used as an animal repellent such as cat, dog and bird repellents, for prevention of cannibalism in pigs, to keep horses from chewing their stalls, deer from nibbling tree shoots, and to keep hedgehogs from eating slug pellets (Payne 1988).

The use of denatonium compounds, in particular Denatonium Benzoate (DB) as aversive agents is known. See U.S. Pat. Nos. 3,080,327, 3,268,577, 4,661,504 and 4,652,577.

EP0173410A1 discloses a composition for repelling birds or other creatures and containing a known repellent, characterized in that it also includes a terpene and/or terpene polymer.

While these formulations are interesting, there remains a need for non-toxic insect repellents.

There are some 5 to 30 million insect species estimated in the world—and the majority of these have yet to be collected or named by science. The most well-known insects are those that cause disease or compete for human agricultural products, but these insects represent only a small fraction of the world's insect population. In reality, most insects are beneficial to humans and the environment, not detrimental. Without insects, the environment could not function as it does, yet few of us have considered how these numerous and varied organisms actually affect our lives.

One of the most important services insects provide is pollination. Though some plants are self-pollinated or wind pollinated, many flowering plants rely on insects to transport their pollen to other flowers, ensuring fertilization. Insects visit flowers to collect nectar, but many have specialized anatomy for carrying the pollen they inevitably brush up against. Bees commonly collect pollen in “baskets” formed by stiff hairs on their hind legs or abdomens.

As far as important species go, bees are top of the list. They are critical pollinators: they pollinate 70 of the around 100 crop species that feed 90% of the world. Honey bees are responsible for $30 billion a year in crops.

If bees become extinct we may lose all the plants that bees pollinate, all of the animals that eat those plants and so on up the food chain. Which means a world without bees could struggle to sustain the global human population of 7 billion. Our supermarkets would have half the amount of fruit and vegetables.

Now we are losing bees at an alarming rate. Three Possible reasons include the loss of flower meadows, the crab-like varroa mite that feasts on their blood, climate change, and use of pesticides and insecticides.

There remains a need for alternative insect repellent composition.

The present invention solves the above problem by providing a composition comprising aversive agent only acts as a repellent without causing any physical damage to the insects.

### OBJECTS OF THE INVENTION

It is an object of the present invention to provide a composition comprising aversive agent as insect repellent in agriculture and horticulture.

It is another object of the present invention to provide use of denatonium compound which act as a repellent to insects such as honey bees, bed bugs, in addition to reptiles such as lizards, also the mammals such as deer, nilgai, rodents which are causing damage/harm to agriculture and horticulture without killing them.

### SUMMARY OF INVENTION

According to an aspect of the present invention there is provided an insect repellent composition comprising bittering agent.

In an aspect the present invention provides a composition comprising Denatonium compound as active insect repellent.

In another aspect the present invention provides a process for preparation of said insect repellent composition.

According to another aspect of the present invention, there is provided a method of repelling insects, mammals and reptiles comprising treating the subject to be treated with the composition comprising denatonium compound.

In another aspect the present invention provides use of denatonium compound for repelling insects, mammals and reptiles.

### DETAILED DESCRIPTION OF THE INVENTION

For the purposes of the following detailed description, it is to be understood that the invention may assume various alternative variations and step sequences, except where expressly specified to the contrary. Moreover, other than in any operating examples, or where otherwise indicated, all numbers expressing, for example, quantities of materials/ingredients used in the specification are to be understood as being modified in all instances by the term “about”. The term “about” used to qualify the amounts of active agent shall be interpreted to mean “approximately” or “reasonably close to” and any statistically insignificant variations therefrom.

Thus, before describing the present invention in detail, it is to be understood that this invention is not limited to particularly exemplified systems or process parameters that may of course, vary. It is also to be understood that the terminology used herein is for the purpose of describing particular embodiments of the invention only and is not intended to limit the scope of the invention in any manner. The use of examples anywhere in this specification including examples of any terms discussed herein is illustrative only, and in no way limits the scope and meaning of the invention or of any exemplified term. Likewise, the invention is not limited to various embodiments given in this specification.

It must be noted that, as used in this specification, the singular forms “a,” “an” and “the” include plural referents unless the content clearly dictates otherwise. The terms “preferred” and “preferably” refer to embodiments of the invention that may afford certain benefits, under certain circumstances.

As used herein, the terms “comprising” “including,” “having,” “containing,” “involving,” and the like are to be understood to be open-ended, i.e., to mean including but not limited to.

The present inventors surprisingly found that the composition comprising denatonium compound of the present invention act as a repellent to insects such as honey bees, bed bugs, in addition to rodents, reptiles such as lizards, also the mammals such as deer, rodents, nilgai which causes damage/harm agriculture and horticulture without killing them.

Hence, the present invention shows wide applicability within agriculture and horticulture as repellent for vermin and other species. Ethical concerns are also accounted by means of using denatonium compound repellent composition which is not harmful.

Accordingly, the present invention provides a composition comprising Denatonium compound as active insect repellent.

It is observed that the mammal species which are declared vermin by government and causing a large-scale agriculture loss they are also repelled by the denatonium compound because of its bitterness e.g. Nilgai, deer are effectively repelled by aversive agent, particularly Denatonium Benzoate.

In addition to these to reptiles such as lizard, snakes, arthropods like spiders, toribolium species like Wood Borer/Woodboring beetles are repelled by the denatonium composition of the present invention.

Bed bugs are a type of insect that feed on human blood, usually at night. Their bites can result in a number of health effects including skin rashes, psychological effects and allergic symptoms. Bed bug bites may lead to skin changes ranging from invisible to prominent blisters. Symptoms may take between minutes to days to appear. Itchiness is common, while some may feel tired or have a fever. Typically, uncovered areas of the body are affected and three bites occur in a row. Bed bugs bites are not known to transmit any infectious disease.

The present invention solves the bed bug problem without killing them hence indirectly inhibits the infectious diseases another advantage of composition comprising denatonium compound.

It is said that snakes are farmer's friend because they feed on rodents like mice. The snake bite is one of the major problems faced by farmers. Farmers are always trying to kill them for safety which leads to loss of the important snake species which our food chain wants. This causes ecological imbalance in food chain. The present invention solves the aforesaid problem by simply repelling snakes, rodents. In addition to above Garden snails are also repelled by the composition comprising Denatonium compound of the present invention.

The present invention relates to a composition comprising aversive agent to be used for vermin/insect repellent. The present invention more particularly relates to Denatonium compound which acts as repellent without harming the life of the insects such as honey bees, bed bugs, in addition to reptiles such as lizards, also the mammals such as deer, rodents. It also acts as a repellent for crop damaging animals like nilgai.

In an embodiment aversive agent is Denatonium salt.

In an embodiment, Denatonium compound is selected from the group consisting of denatonium chloride, denatonium citrate, denatonium saccharide, denatonium carbonate, denatonium acetate, denatonium benzoate, denatonium benzoate monohydrate and mixtures thereof.

In an embodiment, the aversive agent is denatonium benzoate.

In an embodiment, there is provided an insect repellent composition comprising denatonium benzoate.

In an embodiment, the composition comprising denatonium compound is effective for all the insects and animals.

In an embodiment, the present composition comprises
1. at least one denatonium compound and
2. a carrier

In an embodiment, the carrier used can be any carrier conventionally used in insect repellent formulations.

In an embodiment, the carrier used in the composition is a surfactant.

In an embodiment present invention provide an insect repellent composition comprising
1. at least one denatonium compound
2. at least one surfactant
3. optionally essential oil

In an embodiment present invention provide an insect repellent composition comprising
1. denatonium benzoate;
2. at least one surfactant and
3. optionally essential oil

In an embodiment the active insect repellent is denatonium compound used in an amount in the range of 0.01-50% w/w.

In an embodiment the active insect repellent is denatonium compound used in an amount in the range of 1-50% w/w.

In an embodiment the active insect repellent is denatonium compound used in an amount in the range of 1-25% w/w.

In an embodiment the carrier is a surfactant and used in an amount in the range of 1-25% w/w.

In an embodiment the essential oil is used in an amount

In an embodiment, the composition further comprises at least one surfactant, solvent, water, stabilizer, plant extract or essential oil.

The surfactant used in the composition is selected from the group comprising PVA, V pyrrolidone or PV pyridine, oxirane, methyl-, polymer with oxirane, mono(3,5,5-trimethylhexyl) ether+Styrene acrylic polymer in combination.

In some embodiments, the composition comprising denatonium compound as insect repellent further comprising at least one selected from sodium lauryl sulphate, polyvinyl acetate, polyvinyl pyridine, polyvinyl pyrrolidone, styrene acrylic polymer, alkoxylates (Teg wet 500), kaolin clay, oils such as clove oil, cinnamon oil, castor oil, peppermint oil, garlic extract, walnut shells and water.

In an embodiment the composition may further comprising a fragrance.

The composition may comprise at least one fragrance selected from neroli oil, anethole, rose oil, violet extract, mandarin oil, methylionone, sandal wood, musk and patchouli.

In an embodiment, the surfactant is selected from the below groups.

1) Anionic: sulfate, sulfonate, and phosphate, carboxylate derivatives: Anionic surfactants contain anionic functional groups at their head, such as sulfate, sulfonate, phosphate, and carboxylates. Prominent alkyl sulfates include ammonium lauryl sulfate, sodium lauryl sulfate (sodium dodecyl sulfate, SLS, or SDS), and the related alkyl-ether sulfates sodium laureth sulfate (sodium lauryl ether sulfate or SLES), and sodium myreth sulfate. Carboxylates are the most common surfactants and comprise the carboxylate salts (soaps), such as sodium stearate. More specialized species include sodium lauroyl sarcosinate and carboxylate-based fluorosurfactants such as perfluorononanoate, perfluorooctanoate (PFOA or PFO).

2) Cationic: pH-dependent primary, secondary, or tertiary amines; primary and secondary amines become positively charged at pH<10: octenidine dihydrochloride. Permanently charged quaternary ammonium salts: cetrimonium bromide (CTAB), cetylpyridinium chloride (CPC), benzalkonium chloride (BAC), benzethonium chloride (BZT), dimethyl dioctadecyl ammonium chloride, and dioctadecyl dimethyl ammonium bromide

3) Zwitterionic: Zwitterionic (amphoteric) surfactants have both cationic and anionic centers attached to the same molecule. The cationic part is based on primary, secondary, or tertiary amines or quaternary ammonium cations. The anionic part can be more variable and include sulfonates, as in the sultaines CHAPS (3-[(3-cholamidopropyl)dimethylammonio]-1-propanesulfonate) and cocamide. Betaines such as cocamidopropyl betaine have a carboxylate with the ammonium. The most common biological zwitterionic surfactants have a phosphate anion with an amine or ammonium, such as the phospholipids phosphatidylserine, phosphatidylethanolamine, phosphatidylcholine, and sphingomyelins.

4) Non-ionic surfactants have covalently bonded oxygen-containing hydrophilic groups, which are bonded to hydrophobic parent structures. The water-solubility of the oxygen groups is the result of hydrogen bonding. Hydrogen bonding decreases with increasing temperature, and the water solubility of non-ionic surfactants therefore decreases with increasing temperature.

Ethoxylates

Fatty alcohol ethoxylate, Narrow-range ethoxylate, Octaethylene glycol monododecyl ether, Pentaethylene glycol monododecyl ether

Alkylphenol ethoxylates (APEs): Nonoxynols, Triton X-100

Fatty acid ethoxylates, Fatty acid ethoxylates are a class of very versatile surfactants, which combine in a single molecule the characteristic of a weakly anionic, pH-responsive head group with the presence of stabilizing and temperature responsive ethyleneoxide units.

Special Ethoxylated Fatty Esters and Oils

Ethoxylated amines and/or fatty acid amides: Polyethoxylated tallow amine, Cocamide monoethanolamine, Cocamide diethanolamine, Terminally blocked ethoxylate, Poloxamers

Fatty acid esters of polyhydroxy compounds

Fatty acid esters of glycerol: Glycerol monostearate, Glycerol monolaurate

Fatty acid esters of sorbitol

Spans: Sorbitan monolaurate, Sorbitan monostearate, Sorbitan tristearate,

Tweens (polysorbate): Tween 20, Tween 40, Tween 60, Tween 80

Fatty acid esters of sucrose

Alkyl polyglucosides

Alkyl polyglycoside: Decyl glucoside, Lauryl glucoside, Octyl glucoside

Amine oxides: Lauryl dimethylamine oxide

Typically, the surfactants are compounds that reduces surface tension when dissolved in water or water solutions, or reduces the interfacial tension between two liquids, or between a liquid and a solid. Preferably, surfactants, such as sodium lauryl sulphate provides beneficial effective improvement in the insect repellent composition.

The composition of present invention can further comprise other ingredients and excipients, which may be physiologically inactive for example gum, stabilizer and the like.

In one embodiment the present composition is formulated in the form of liquid or solid.

The liquid formulation of present invention is in the form of solution, suspension, or emulsion.

The solid formulation of present invention is a granular formulation.

In a further embodiment of this invention, the repellent compositions are made in a gel and spray forms.

In some embodiment the present composition can be formulated as gel.

The gel formulation may be prepared by mixing the active denatonium compound with liquid gel wax and the mixture is poured into a mold to solidify after which the solidified mixture may be exposed to air to disperse the gel formulation.

In a further embodiment of this invention, the repellent compositions are made in emulgel, cream, lotion and spray forms.

In another aspect the present invention provides a process for preparation of a composition comprising denatonium compound as insect repellent.

In one embodiment the composition is liquid formulation.

In one embodiment the process for preparing liquid composition comprises the steps of

1. taking solvent in a container and keep under stirring.

2. adding surfactant in the solvent under stirring till it forms a homogenous solution.

3. adding acrylic polymer under stirring to the above homogenous solution

4. adding denatonium benzoate to the above mixture to form a composition.

In another embodiment the composition is a solid formulation.

In an embodiment the solid formulation is a granule form.

In one embodiment the process for preparing solid composition comprises the steps of:

1. mixing inerts in a container in a geometric proportion.

2. adding denatonium benzoate to above mixture

3. sieving if required to ensure uniform particle size.

In another embodiment the composition is a semisolid formulation.

In an embodiment the semi-solid formulation is a gel or a cream formulation or the like.

In this embodiment the process for preparing semisolid composition comprises the steps of:

1. mixing water soluble inerts in aqueous phase under stirring.

2. adding oil soluble ingredients and mix them in oil under stirring to form a homogenous mixture.

3. adding oil into water or water into oil depending on what type of emulsion is required.

4. reducing the particle size by known methods for example in triple roller mill or colloidal mill or any other suitable mill.

In an embodiment, the repellent formulation is a gel and can be prepared by mixing about four ounces of the repellent formulation selected from all the above formulations and land volatile oil into liquid gel wax and the mixture is poured into a mold to solidify after which the solidified mixture may be exposed to air to disperse the formulation.

In another embodiment the composition is an oil-based formulation which could be granules or a powder formulation.

In this embodiment the process for preparing oil-based composition comprises the steps of:

1. taking oil in a container and keep it under stirring.

2. adding inert excipients into the oil which is under stirring till it forms a homogenous mixture.

3. adding denatonium benzoate to the above solution till it forms homogenous suspension.

In an embodiment of the present invention there is provided a method of repelling insects, mammals and reptiles comprising applying an effective amount of insect repellent composition to a surface in need of repelling insects.

In an embodiment, present invention provides a method for repelling insects which comprises applying a insect repellent composition to the area to be made repellent, said composition comprising denatonium compound as insect repellent.

In another embodiment, the present invention provides a kit comprising composition comprising denatonium compound as insect repellent and an instruction manual to use the same.

In an embodiment the present composition is effectively repels insects.

In an embodiment, the present composition is an effective insect repellent which is environmentally safe and friendly.

### Advantages of the Present Invention

1) The present repellent formulations can be used for indoor and outdoor purpose.
2) Application of the present repellent formulations to hard surfaces and grass areas will repel Canadian geese and blackbirds from surfaces treated
3) It can be applied to plants
4) The formulation can also be applied onto a ribbon, or net of any type and size and placed around areas to be protected. For example, it may be applied to a string or rope or net and hung from any elevation, for example from a tree. One or more coated strips or ribbons may be hung from any one elevated Structure.
5) The solid formulations of present invention can be used for Deterring Predators.

6) The liquid formulation can be used as a repellent Formulation for Pets
7) The present formulations can be formulated in the form of Aerial Application Formulation, as a Seed Application Formulation, Fertilizer Application Formulation, can be formulated as a controlled released formulation, Repellent Seed Composition. Treated seeds are resistant to consumption and destruction by birds, rodents and insects.
8) The present formulation can be used as a snake repellent and snail repellent formulation

It will be understood that the specification and examples are illustrative but not limitative of the present invention and that other embodiments within the spirit and scope of the present invention will suggest themselves to those skilled in the art. Other embodiments can be practiced that are also within the scope of the present invention. The following examples illustrate the invention, but by no means intend to limit the scope of the claims.

### EXAMPLES

### Example 1

TABLE 1
FORMULATION FOR [symbol] AND WILD BOARS
LIQUID FORMULATIONS

| | FORMU- | FORMU- | FORMU- | FORMU- | FORMU- | FORMU- |
|---|---|---|---|---|---|---|
| INGREDIENT OF | LATION 1 | LATION 2 | LATION 3 | LATION 4 | LATION 5 | LATION 6 |
| THE COMPOSITION | Weight % of the components | | | | | |
| [symbol] | 0.05 | 5 | [symbol] | 15 | 20 | 30 |
| Sodium Lauryl | 0.002 | 0.006 | 0.9 | 1.2 | 2.5 | 3 |
| [symbol] | | | | | | |
| Xanthan Gum | 0.1 | 0.1 | 0.1 | | — | 2.5 |
| [symbol] | 20 | | — | 0.05 | 5 | 5 |
| Polyvinyl pyridine | | [symbol] | | 10 | | 0.5 |
| Polyvinyl [symbol] | | | 6 | | [symbol] | 7 |
| Clave oil | 0.01 | | | | 0.1 | |
| [symbol] Oil | | 0.005 | | | | 0.01 |
| [symbol] extract | | | | 0.5 | | |
| Water | q.s. | q.s. | q.s. | q.s. | q.s. | q.s. |
| OBSERVATION | Dispersibility is | Dispersibility is | Dispersibility is | Excellent | High viscosity | Thick solution. |
| | satisfactory. | satisfactory. | satisfactory. | dispersability and | solution. | Excellent |
| | Thick film | Film is not | [symbol] | uniform thin | Excellent | dispersability |
| | formation. | uniform | film [symbol] | film formation | dispersability | and uniform |
| | | | | | and uniform | thin film |
| | | | | | thin film | formation |
| | | | | | formation | |

[symbol]

indicates data missing or illegible when filed

TABLE 2
GRANULATION FORMULATIONS FOR (e.g., Mice, Rabbits, Squirrels, And Groundhogs)

| | FORMU- | FORMU- | FORMU- | FORMU- | FORMU- | FORMU- |
|---|---|---|---|---|---|---|
| INGREDIENT OF | LATION 1 | LATION 2 | LATION 3 | LATION 4 | LATION 5 | LATION 6 |
| THE COMPOSITION | Weight % of the components | | | | | |
| [symbol] Benzoate | 0.05 | 5 | 7.5 | 15 | 20 | [symbol] |
| Xanthan Gum | 0.1 | 0.1 | 0.1 | | — | 2.5 |
| Polyvinyl Acetate | | 10 | | 7.5 | 1 | 0.5 |
| Polyvinyl [symbol] | 7.5 | | — | 5 | | 2.5 |
| Polyvinyl pyridine | | | 8 | | 5 | 0.2 |
| Kaolin Clay | 9.01 | 0.05 | 1.1 | — | 0.05 | 0.06 |
| Cinnamon oil | 5-10 | 0.1-15 | | | | |
| Peppermint Oil | | | 10.8 | 0.04-15 | | |
| Garlic extract | | | | | 0.05-2 | 1.1 |
| [symbol] shells | | 0.01-5 | | 0.01-5 | | 0.01-5 |
| OBSERVATION | Hard granules. | Hard granules | Soft granules. | Appropriate | Appropriate | Appropriate |
| | Doesn't | with lot of | On [symbol] | hardness | hardness | hardness |
| | disintegrate | dusting | burst open. | with less | with less | with less |
| | easily | during [symbol] | | dusting. | dusting. | dusting. |
| | | test | | Satisfactory | Satisfactory | Satisfactory |
| | | | | dispersability | dispersability | dispersability |
| | | | | in water. | in water | in water. |

[symbol]

indicates data missing or illegible when filed

TABLE 3
SPRAY FORMULATION FOR PIG AND

[symbol]

| | FORMU- | FORMU- | FORMU- | FORMU- | FORMU- | FORMU- |
|---|---|---|---|---|---|---|
| INGREDIENTS OF | LATION 1 | LATION 2 | LATION 3 | LATION 4 | LATION 5 | LATION 6 |
| THE COMPOSITION | Weight % of the components | | | | | |
| [symbol] | 0.05 | 5 | 7.5 | [symbol] | [symbol] | [symbol] |
| Polyvinyl Acetate | | 10 | | 4 | [symbol] | 2.5 |
| Polyvinyl Pyrrolidone | 10 | | | 3.5 | | 2.5 |
| Polyvinyl pyridine | | | 5.5 | | 2.5 | 2.5 |
| [symbol] oil | 0.1-5 | — | [symbol] | 0.02 | 0.3 | — |
| Peppermint Oil | | | 0.1-2 | | | |
| [symbol] | | | | 0.04 | 0.05 | 1.1 |
| Water | q.s. | q.s. | q.s. | q.s. | q.s. | q.s. |
| OBSERVATION | Dispersability is | Dispersability is | Dispersability is | Excellent | Excellent | Excellent |
| | satisfactory. | satisfactory. | satisfactory. | dispersability | [symbol] | dispersability |
| | Thick film | Film is | Uneven | and [symbol] | | and [symbol] |
| | formation. | set | film | the film | | film |
| | Film [symbol] | [symbol] | [symbol] | [symbol] | | formation |
| | easily. | | | | | |

[symbol]

indicates data missing or illegible when filed

TRIAL 4
LIQUID FORMULATION FOR RATS AND LIZARD
WHEN FORMULATION IS PREPARED USING [symbol] BENZOATE WITH [symbol]
COMPOUND, THE REPELLENCE EFFECT OF [symbol] BENZOATE IS ENHANCED.

| INGREDIENTS OF | | | | | | | | | |
|---|---|---|---|---|---|---|---|---|---|
| THE COMPOSITION | TRAIL 1 | TRIAL 2 | TRIAL 3 | TRIAL 4 | TRIAL 5 | TRIAL 6 | TRIAL 7 | TRIAL 8 | TRIAL 9 |
| Chemical | 0.5% DB | 1% DB | 1.5% DB | 0.5% | [symbol] | 1.5% | 0.5% | 1% | 1.5% |
| | Quantity (g) | Quantity (g) | Quantity (g) | | | | | | |
| [symbol] Benzoate | 0.5 | 1 | 1.5 | 0.5 | 1 | 1.5 | 0.5 | 1 | 1.5 |
| Non-ionic surfactant | 16 | 0.05 | 0.1 | 0.5 | 2.5 | 3 | 4 | 5 | 2.5 |
| (1-10) | | | | | | | | | |
| Acrylic Polymer | 0.3 | 4 | 1.5 | 6 | 2.5 | 1.5 | 4 | 2.5 | 1.5 |
| (1-10) | | | | | | | | | |
| [symbol] | NA | NA | NA | [symbol] | Clove | Cinnamon | Ginger | [symbol] | Peppermint |
| Compound | | | | | | | | | |
| Water | q.s. | q.s. | q.s. | q.s. | q.s. | q.s. | q.s. | q.s. | q.s. |
| OBSERVATIONS | Milky solution. | Milky solution. | Milky solution. | Clear | Clear | Clear | Clear | Clear | Clear |
| | Stable and no | Stable and no | Viscosity is | solution. | solution. | solution. | solution. | solution. | solution. |
| | layer | layer | slightly higher. | | | | | | |
| | separation | separation | Layer separation | | | | | | |
| | | | after 5-6 | | | | | | |
| | | | hrs which is | | | | | | |
| | | | easily [symbol] | | | | | | |
| REPELLANCE | GOOD | EXCELLENT | EXCELLENT | Not as | Not as | Not as | Not as | Not as | Not as |
| | | | | effective | effective | effective | effective | effective | effective |
| | | | | as DB | as DB | as DB | as DB | as DB | as DB |

[symbol]

indicates data missing or illegible when filed

TRIAL 5
LIQUID FORMULATION FOR RATS AND LIZARD

| | TRIAL 1 | TRIAL 2 | TRIAL 3 | TRIAL 4 | TRIAL 5 | TRIAL 6 | TRIAL 7 | TRIAL 8 | TRIAL 9 |
|---|---|---|---|---|---|---|---|---|---|
| | 0.5% DB | 1% DB | 1.5% DB | 0.5% DB | 1% DB | 1.5% DB | 0.5% DB | 1% DB | 1.5% DB |
| INGREDIENTS OF | Quantity | Quantity | Quantity | Quantity | Quantity | Quantity | Quantity | Quantity | Quantity |
| THE COMPOSITION | (g) | (g) | (g) | (g) | (g) | (g) | (g) | (g) | (g) |
| [symbol] | 0.5 | 1 | 1.5 | 0.5 | 1 | 1.5 | NA | NA | NA |
| Polyvinyl | | [symbol] | | [symbol] | [symbol] | [symbol] | 10 | [symbol] | 5 |
| Acetate | | | | | | | | | |
| Polyvinyl | [symbol] | [symbol] | 2.5 | 1 | 1 | 1 | | | |
| [symbol] | | | | | | | | | |
| (1-20) | | | | | | | | | |
| Polyvinyl | | | 0.01 | | [symbol] | 2.5 | | 5.5 | 1 |
| [symbol] | | | | | | | | | |
| [symbol] | NA | NA | NA | | | | Ginger | [symbol] | Pepper- |
| Compound | | | | | | | | | mint |
| Water | q.s. | q.s. | q.s. | q.s. | q.s. | q.s. | q.s. | q.s. | q.s. |
| OBSERVATION | Clear | Clear | Milky | Clear | Clear | Milky | Clear | Clear | Clear |
| | solution. | solution. | solution. | [symbol] | solution. | solution. | solution | solution | solution |
| | Stable | Stable | Stable. | Uniform | [symbol] | Viscosity is | | | |
| | and | [symbol] | [symbol] | and | Uniform | slightly | | | |
| | [symbol] | | | [symbol] | and | [symbol] | | | |
| | layer | | | | [symbol] | Layer | | | |
| | separation. | | | | | separation | | | |
| | [symbol] | | | | | after | | | |
| | | | | | | 5-6 hrs | | | |
| | | | | | | which is | | | |
| | | | | | | easily | | | |
| | | | | | | [symbol] | | | |
| REPELLANCE | GOOD | EXCELLENT | EXCELLENT | GOOD | EXCELLENT | EXCELLENT | | | |

[symbol]

indicates data missing or illegible when filed

TRIAL 6
OIL BASED FORMULATION FOR ANIMAL REPELLENT

| | FORMU- | FORMU- | FORMU- | FORMU- | FORMU- | FORMU- |
|---|---|---|---|---|---|---|
| INGREDIENTS OF | LATION 1 | LATION 2 | LATION 3 | LATION 4 | LATION 5 | LATION 6 |
| COMPOSITION | Weight % of the components | | | | | |
| [symbol] | 0.5 | 1 | 1.5 | 0.5 | 1 | 3.5 |
| Benzoate | | | | | | |
| Polyvinyl Acetate | | [symbol] | — | 5 | 4 | 4 |
| Polyvinyl [symbol] | 5.5 | | | 2.5 | | 2 |
| Polyvinyl [symbol] | | | 6 | | 5.5 | 1 |
| Cinnamon oil | 2.5 | — | 0.5 | 2.5 | 4 | — |
| Peppermint Oil | | | 2.5 | | | |
| [symbol] extract | | | | 2 | 1 | [symbol] |
| Oil (Castor Oil) | q.s. | q.s. | q.s. | q.s. | q.s. | q.s. |
| OBSERVATIONS | [symbol] it's | [symbol] it's | [symbol] it's | [symbol] it's | [symbol] it's | [symbol] it's |
| | a clear | a clear | a clear | a clear | a clear | a clear |
| | solution. | solution. | solution. | solution. | solution. | solution. |
| | [symbol] | [symbol] | [symbol] | [symbol] | [symbol] | [symbol] |
| | Easily | Hard | Easily | Easily | Easily | Easily |
| | dispersable. | film. | dispersable. | dispersible. | dispersable. | dispersable. |
| | Film [symbol] | | [symbol] | [symbol] | [symbol] | [symbol] |

[symbol]

indicates data missing or illegible when filed

1. An insect repellent composition comprising a denatonium compound and a carrier.

2. The composition as claimed in claim 1, wherein said denatonium compound is denatonium chloride, denatonium citrate, denatonium saccharide, denatonium carbonate, denatonium acetate, denatonium benzoate, denatonium benzoate monohydrate, or a mixture thereof.

3. The composition as claimed in claim 1, wherein said denatonium compound is denatonium benzoate.

4. The composition as claimed in claim 1, wherein said carrier comprises sodium lauryl sulphate, polyvinyl acetate, polyvinyl pyridine, polyvinyl pyrrolidone, styrene acrylic polymer, Teg wet 500, kaolin clay, essential oils, plant extracts, water, or a combination thereof.

5. The composition as claimed in claim 1, wherein said denatonium compound is in an amount in the range of 0.01 to 50% w/w based on the total weight of the composition.

6. The composition as claimed in claim 1, wherein said carrier is in an amount in the range of 1% to 25% w/w based on the total weight of the composition.

7. An insect repellent liquid formulation comprising a denatonium compound and a carrier.

8. An insect repellent solid composition comprising a denatonium compound and a carrier.

9. A method for repelling insects comprising applying the composition of claim 7 to the locus of insects.
